(19) United States
(12) Patent Application Publication
(10) Pub. No.: US 2014/0196928 A1
(43) Pub. Date: Jul. 17, 2014

(54) WIRING DISTRIBUTION SYSTEM AND APPARATUS

(71) Applicant: Hwai Yang, Saint Louis, MO (US)

(72) Inventor: Hwai Yang, Saint Louis, MO (US)

(21) Appl. No.: 14/153,857

(22) Filed: Jan. 13, 2014

Related U.S. Application Data
(60) Provisional application No. 61/752,094, filed on Jan. 14, 2013.

(30) Foreign Application Priority Data
Jun. 26, 2013 (CA) 2819420

(51) Int. Cl. H02G 3/04; H02G 11/00

(52) U.S. Cl. CPC H02G 3/0406; H02G 11/00
USPC 174/68.3

(57) ABSTRACT

A system and apparatus for the distribution of wiring is provided. The present invention includes an anchor that may be attached to a wall, ceiling or floor. A routing channel connected to the anchor may route wiring from a power source to at least one conduit extension. The conduit extensions may include at least two substantially horizontal wire distribution channels that may be connected via rotatable joints. A substantially vertical wire distribution channel may be connected to one of the horizontal wire distribution channels and rest on a surface, such as a floor. At least one information or power port may be attached to the vertical wire distribution channel. The wiring may run through the channels and connect with the port. Therefore, a user may manipulate the channels to a proper position and plug in electronic devices to the port.

### CROSS-REFERENCE TO RELATED APPLICATION

This application claims the benefit of priority of U.S. provisional application No. 61/752,094, filed Jan. 14, 2013, the contents of which are herein incorporated by reference.

### BACKGROUND OF THE INVENTION

The present invention relates to an overhead, rotating, and articulating cabling/wiring distribution system for providing power, data, telecommunications, and video to multiple locations in a room.

In the commercial office, retail, educational and healthcare environments, the supply of power, wired data and telecommunications, and video, is often in fixed locations. This stationary characteristic limits the flexibility of tenants, retailers and facility owners to adapt their work and retail environments quickly and cost effectively. Existing devices are static and serve as a limiting factor to floor plan and furniture layout changes. Existing devices require the installation of a new power, data & telecommunications, and video supply.

As can be seen, there is a need for solutions to these and other problems.

### SUMMARY OF THE INVENTION

In one aspect of the present invention, an apparatus for distributing wires comprises: an anchor configured to attach the apparatus to at least one of a ceiling, wall, and floor; a source of at least one of power and information; a routing channel containing wires from the source; at least one conduit extension comprising: a plurality of substantially horizontal wire distribution channels, wherein at least one of the substantially horizontal wire distribution channels is connected to the routing channel, wherein at least two of the substantially horizontal wire distribution channels are connected together via a first rotatable joint; and a substantially vertical wire distribution channel connected to at least one of the substantially horizontal wire distribution channels and comprising at least one port connected by the wires to the source.

These and other features, aspects and advantages of the present invention will become better understood with reference to the following drawings, description and claims.

### BRIEF DESCRIPTION OF THE DRAWINGS

FIG. 1 is an exploded view of the present invention showing the wiring within the channels;

FIG. 2 is a perspective view of the present invention; and

FIG. 3 is a perspective view of an alternative embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and apparatus for the distribution of wiring. The present invention includes an anchor that may be attached to a wall, ceiling or floor. A routing channel connected to the anchor may route wiring from a power source to at least one conduit extension. The conduit extensions may include at least two substantially horizontal wire distribution channels that may be connected via rotatable joints. A substantially vertical wire distribution channel may be connected to one of the horizontal wire distribution channels and rest on a surface, such as a floor. At least one information or power port may be attached to the vertical wire distribution channel. The wiring may run through the channels and connect with the port. Therefore, a user may manipulate the channels to a proper position and plug in electronic devices to the port.

The present invention includes an overhead, rotating, and articulating cabling/wiring distribution system for providing power, data, telecommunications, and video to multiple locations in a room. The rotating and articulating distribution system according to the present invention may utilize new and/or reuse existing wall, ceiling, or floor sources for power, data, telecommunications, and video and extend the range of these utilities. The increased range offers the user tremendous flexibility in rearranging furniture and equipment locations quickly and frequently.

The overhead articulating distribution system may be installed by anchoring the system to existing infrastructure (e.g., ceiling, wall, floor, etc.). Power, data, telecommunication, and video wiring/cabling may be distributed through two rotating and articulating channels and terminates in a vertical channel with outlets and ports. As a result of the rotating and articulating features, the system offers the user flexibility to locate power, data, telecommunication, and video outlets in a multiple number of configurations by manually moving the outlets and ports (located in the vertical channel) to the desired location.

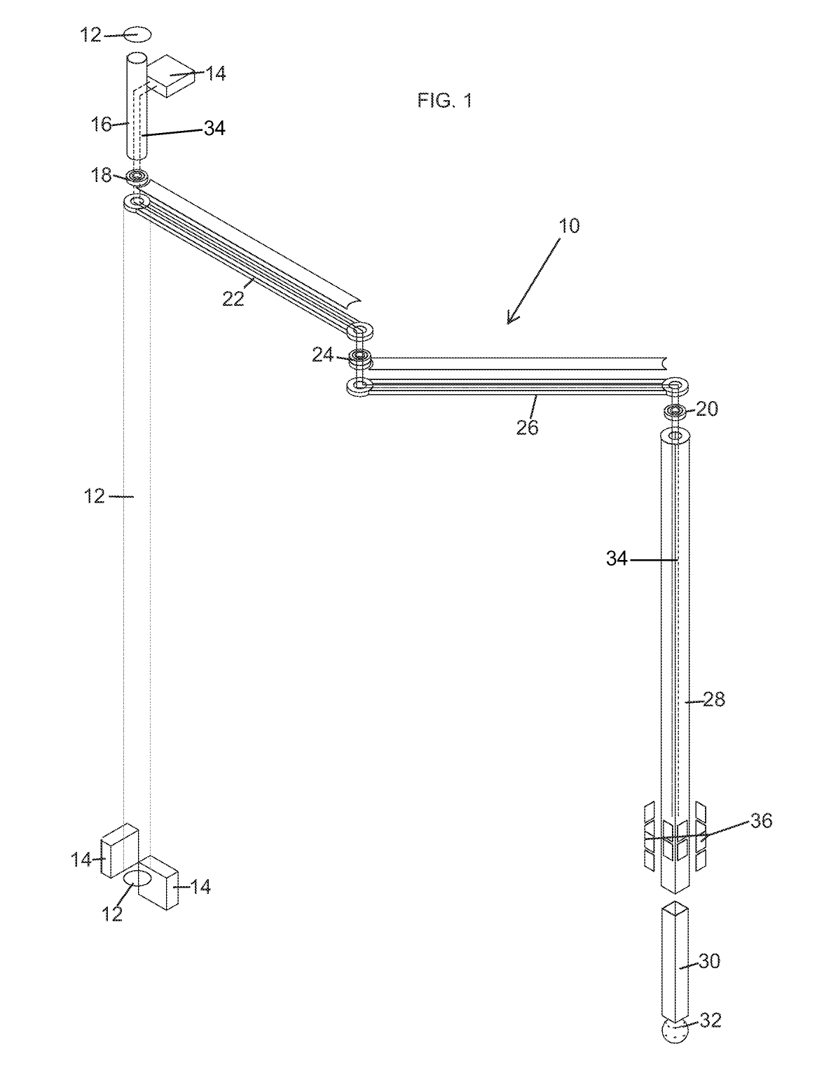

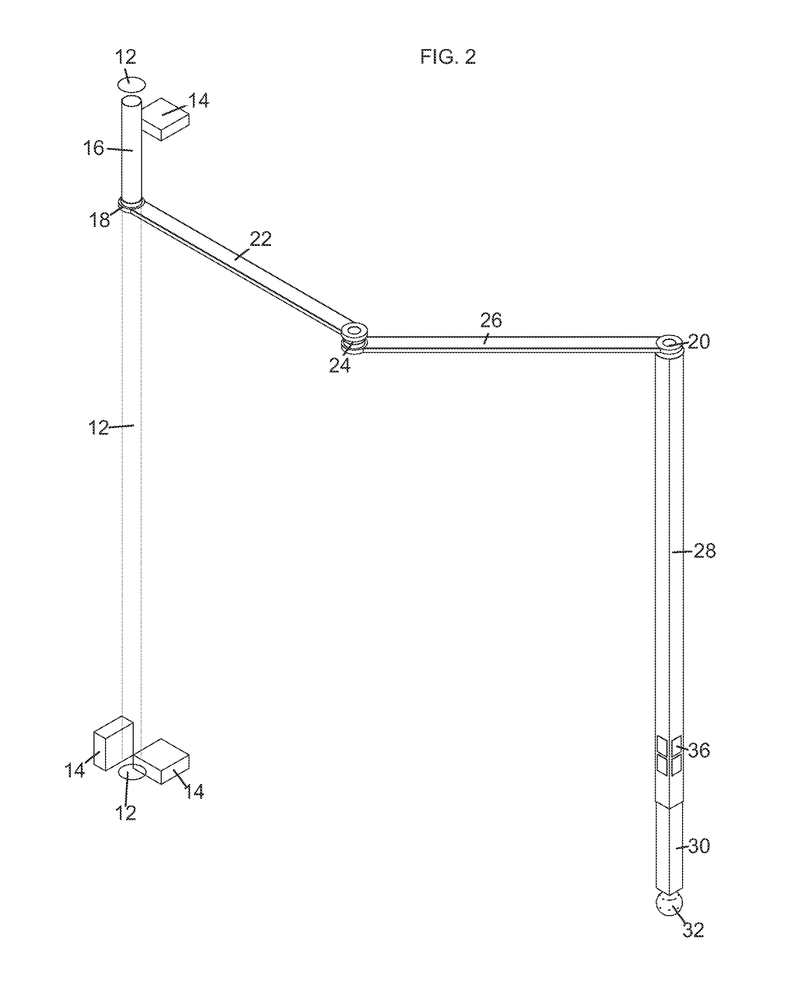

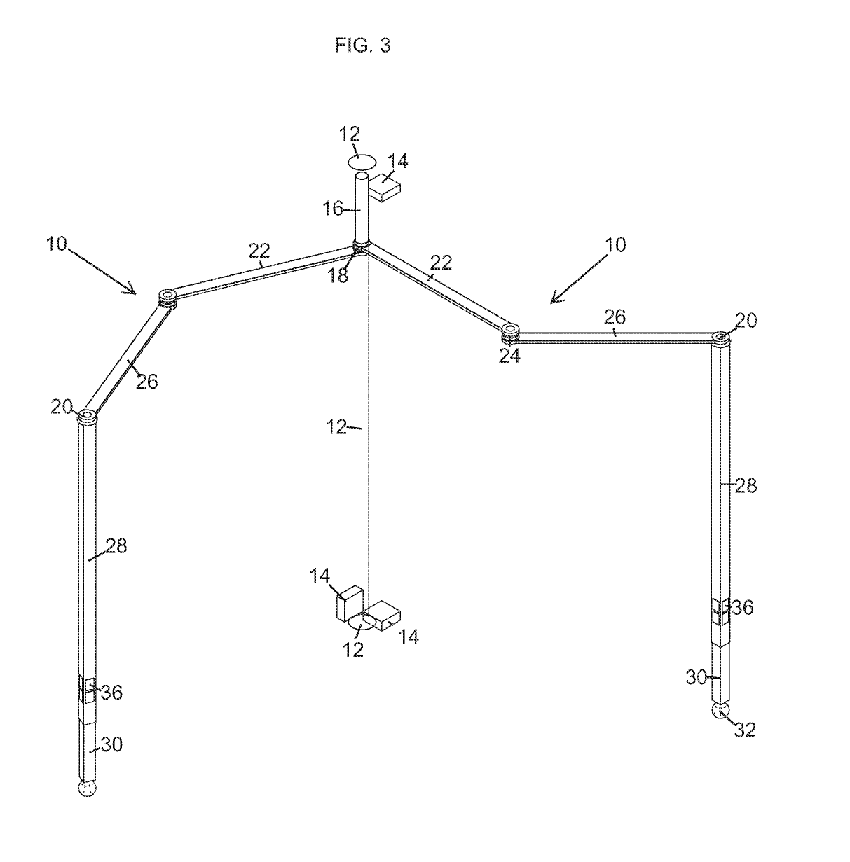

Referring to FIGS. 1 through 3, the present invention may include an apparatus for distributing wires. The present invention may include an anchor 12 that may attach the apparatus to at least one of a ceiling, wall, and floor. The present invention may further include a source 14 of at least one of power and information, such as data, telecommunication, video outlets, and the like. The present invention may further include a routing channel 16 that contains wiring 34 from the source 14. At least one conduit extension 10 may be attached to the routing channel 16. The conduit extensions 10 may allow users to access the source 14 of power and information in desired areas within a home or business.

In certain embodiments the conduit extensions 10 may include a plurality for wire distribution channels. As illustrated in the Figures, the wire distribution channels may include a first substantially horizontal wire distribution channel 22, a second substantially horizontal wire distribution channel 26, and a substantially vertical wire distribution channel 28. The wiring 34 may run through the wire distribution channels mentioned above and may be connected with information and power ports 36, such as outlets, so that users may be connected with the source 14 using the present invention. The wire distribution channels may be a hollow tubular structure or any support frame for supporting the wiring 34.

As illustrated in the Figures, the first horizontal wire distribution channel 22 may be connected to the routing channel 16. In certain embodiments, the first horizontal wire distribution channel 22 may be attached to the routing channel 16 by a first rotatable joint 18. The first rotatable joint 18 facilitates the rotation of the first horizontal wire distribution channel 22 relative to the routing channel 16. Therefore, a user may easily rotate the first horizontal wire distribution channel 22 to a position that is desirable.

In certain embodiments, the second horizontal wire distribution channel 26 may be connected to the first horizontal wire distribution channel 22. The second horizontal wire distribution channel 26 may be connected to the first horizontal wire distribution channel 22 via a second rotatable joint 24. Therefore, the first horizontal wire distribution channel 22 and the second horizontal wire distribution channel 26 may rotate relative to one another and may be rotated to a position that is desirable. In certain embodiments, the second rotatable joint 24 may include two independent free-spinning hollow cores to allow rotation in opposite directions.

Further, the vertical wire distribution channel 28 is connected to the second horizontal wire distribution channel 26. In certain embodiments the second horizontal wire distribution channel 26 may be connected to vertical wire distribution channel 28 via a third rotatable joint 20. The wiring 34 may run from the source 14 through the first horizontal wire distribution channel 22, through the second horizontal wire distribution channel 26 and into the vertical wire distribution channel 28, connecting to at least one information port 36, such as outlets. There may be a plurality of information ports 36 so that the present invention may be used with a plurality of different sources 14 and/or connect multiple devices to the same source 14.

In certain embodiments, an extendable post 30 may be connected to the bottom of the vertical wire distribution channel 28. The extendable post 30 may facilitate vertical height adjustment to varying ceiling heights of the vertical wire distribution channel 28. A roller 32 may be attached to the bottom of the extendable post 30. The roller 32 allows the user to move the system to the desired location. In certain embodiment, the apparatus may be configured so that the horizontal distribution channels 22, 26 are located above heights of humans using the space, and/or may be at least six feet high, and/or may be located close to the ceiling, e.g., within one foot or six inches of the ceiling.

In certain embodiments, the present invention may further include a locking mechanism at one or more joints 18, 20, 24 to keep the wiring distribution apparatus in place. The apparatus may also include motorization to make the device easier to use, such as by allowing horizontal distribution channels 22, 26 to individually or together be rotated about respective joints 18, 20, 24. Further, the present invention may include a restricting device on one and up to all of the rotatable joints 18, 20, 24 may be used to prevent/minimize wire and cable twisting. The present invention may also be used in the manufacturing industry at a physically different scale (e.g., larger and/or taller).

A method of making the present invention may include the following. Assemble the parts as described above and complete wiring as shown in FIG. 1. To use this invention, the user identifies the location where power, data, telecommunications, and video are needed and installs the system. The user is then able to manually move the vertical distribution channel component to multiple locations. Once the channels are manipulated to desired locations, the user may plug equipment into the outlets and/or ports.

It should be understood, of course, that the foregoing relates to exemplary embodiments of the invention and that modifications may be made without departing from the spirit and scope of the invention as set forth in the following claims.

What is claimed is:

1. An apparatus for distributing wires comprising:
an anchor configured to attach the apparatus to at least one of a ceiling, wall, and floor;
a source of at least one of power and information;
a routing channel containing wires from the source;
at least one conduit extension comprising:
a plurality of substantially horizontal wire distribution channels, wherein at least one of the substantially horizontal wire distribution channels is connected to the routing channel, wherein at least two of the substantially horizontal wire distribution channels are connected together via a first rotatable joint; and
a substantially vertical wire distribution channel connected to at least one of the substantially horizontal wire distribution channels and comprising at least one port connected by the wires to the source.

2. The apparatus of claim 1, wherein the plurality of substantially horizontal wire distribution channels comprises at least a first substantially horizontal wire distribution channel connected to the routing channel; and a second substantially horizontal wire distribution channel connected to the first substantially horizontal wire distribution channel via a first rotatable joint

3. The apparatus of claim 1, further comprising an extendable post connected to the substantially vertical wire distribution channel, wherein the extendable post facilitates vertical height adjustment.

4. The apparatus of claim 3, further comprising a rolling mechanism attached to the extending post.

5. The apparatus of claim 2, wherein the first substantially horizontal wire distribution channel is connected to the routing channel via a second rotatable joint.

6. The apparatus of claim 5, wherein the substantially vertical wire distribution channel is connected to the second substantially horizontal wire distribution channel via a third rotatable joint.

7. The apparatus of claim 6, wherein at least one of the first, second and third rotatable joints comprise a locking mechanism.

8. The apparatus of claim 1, comprising a plurality of conduit extensions.

9. The apparatus of claim 8, wherein the plurality of conduit extensions comprises a first conduit extension and a second conduit extension extending from substantially opposite sides of the routing channel.

10. The apparatus of claim 1, wherein the port comprises an outlet.
